(19) United States
(12) Patent Application Publication
(10) Pub. No.: US 2019/0203708 A1
(43) Pub. Date: Jul. 4, 2019

(54) HOLLOW ROTOR LOBE AND CONTROL OF TIP DEFLECTION

(71) Applicant: Eaton Corporaton, Cleveland, OH (US)

(72) Inventor: Andrew S. Meyers, Marshall, MI (US)

(73) Assignee: Eaton Intelligent Power Limited, Dublin (IE)

(21) Appl. No.: 16/311,949

(22) PCT Filed: Jun. 20, 2017
(86) PCT No.: PCT/US2017/038285

§ 371 Date: Dec. 20, 2018

Related U.S. Application Data
(63) Continuation-in-part of application No. 29/588,287, filed on Dec. 20, 2016.
(60) Provisional application No. 62/371,087, filed on Aug. 4, 2016.
(60) Provisional application No. 62/352,403, filed on Jun. 20, 2016.

(51) Int. Cl. F04C 2/12; F04C 2/08; F02B 33/38

(52) U.S. Cl. CPC F04C 2/126; F04C 18/12; F02B 33/38; F04C 2/084

(57) ABSTRACT

A rotor comprises a central body configured to rotate. A lobe extends perpendicularly from the central body along an lobe axis. A curved leading periphery and a curved trailing periphery are on opposite sides of the lobe axis. A V-shaped rib spans between the curved leading periphery and the curved trailing periphery. A first hollow space is bounded by the V-shaped rib, the curved leading periphery, and the curved trailing periphery. The first hollow space is distal with respect to the central body along the lobe axis. A second hollow space is bounded by the V-shaped rib, the central body, the curved leading periphery, and the curved trailing periphery. The second hollow space is proximal with respect to the central body along the lobe axis. The rotor can comprise a plurality of stacked, stamped sheets to form a helically twisted supercharger rotor.

### FIELD

This application provides passive control of a supercharger hollow rotor lobe and lobe tip deflection.

### BACKGROUND

Typically supercharger rotors are made from an aluminum alloy. However, steel rotors are advantageous due to the lower coefficient of thermal expansion, but disadvantageous due to the higher density. The higher density of steel increases the inertia of the rotors, so hollow rotors can be designed to reduce the inertia. However, hollow rotors are more susceptible to increased deflection due to the reduction in support material. The highest deflections of typical hollow rotors are seen on the outer profile of the rotor near the tip and near the pitch diameter. This can result in rotor contact.

### SUMMARY

The methods disclosed herein overcome the above disadvantages and improves the art by way of stamped, stacked rotor sheets configured to decrease deflections seen in the outer profile of the supercharger rotors.

A rotor can comprise a central body configured to rotate. A lobe extends from the central body. The lobe comprises a lobe axis perpendicular to the central body. A curved leading periphery is on a first side of the lobe axis and a curved trailing periphery is on a second side of the lobe axis. A V-shaped rib spans between the curved leading periphery and the curved trailing periphery. A first hollow space is bounded by the V-shaped rib, the curved leading periphery, and the curved trailing periphery. The first hollow space is distal with respect to the central body along the lobe axis. A second hollow space is bounded by the V-shaped rib, the central body, the curved leading periphery, and the curved trailing periphery. The second hollow space is proximal with respect to the central body along the lobe axis. The rotor can comprise a plurality of stacked, stamped sheets of sheet material arranged to form a helically twisted supercharger rotor.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIGS. 1A-1E are views of hollow rotor lobe designs.

FIG. 2 is a section view of a portion of the hollow rotor of FIG. 1E.

FIG. 3 is a view of a plurality of stacked, stamped sheets arranged to form a helically twisted supercharger rotor.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” or “clockwise” and “counter-clockwise” are for ease of reference to the figures.

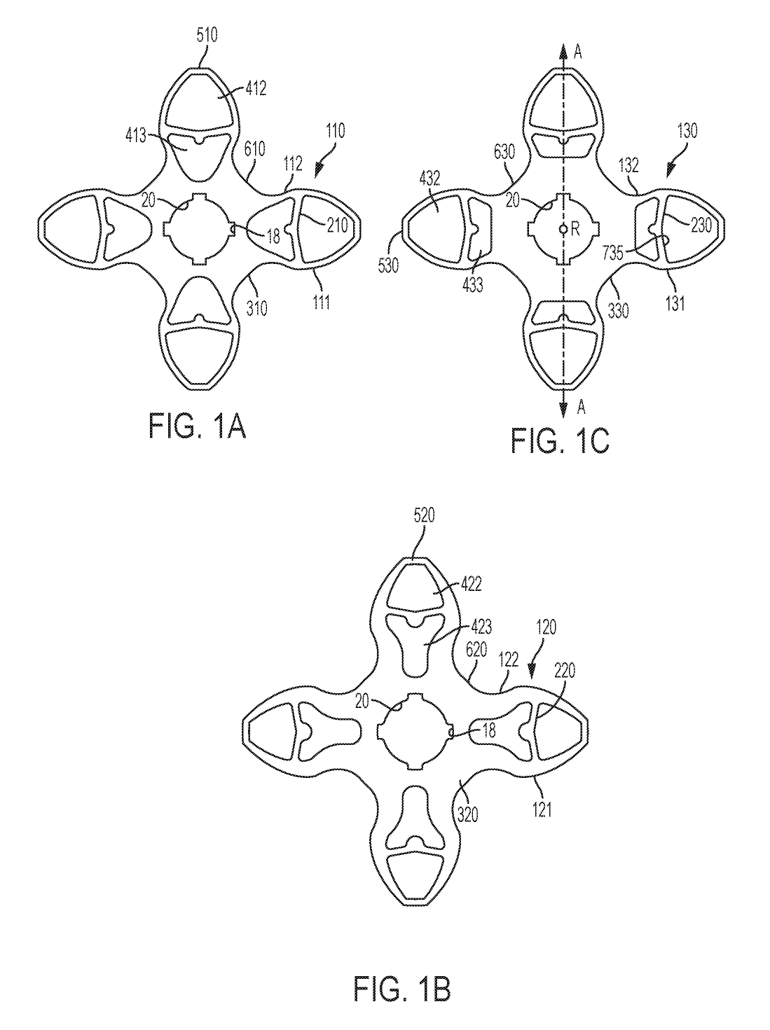

Exemplary rotor profiles are shown in FIGS. 1A-1E. The rotor profiles comprise variant hollow rotor lobes 100, 110, 120, 130, 140, 150 designed to reduce the lobe deflections and tip growth from inertial loads by creating a counteracting force to oppose the unwanted inertial deflections. A supercharger or other positive displacement pump comprising such a designed rotor profile can benefit from having tighter tolerances between the rotors and the associated pump housing, which leads to more control as to pump efficiency.

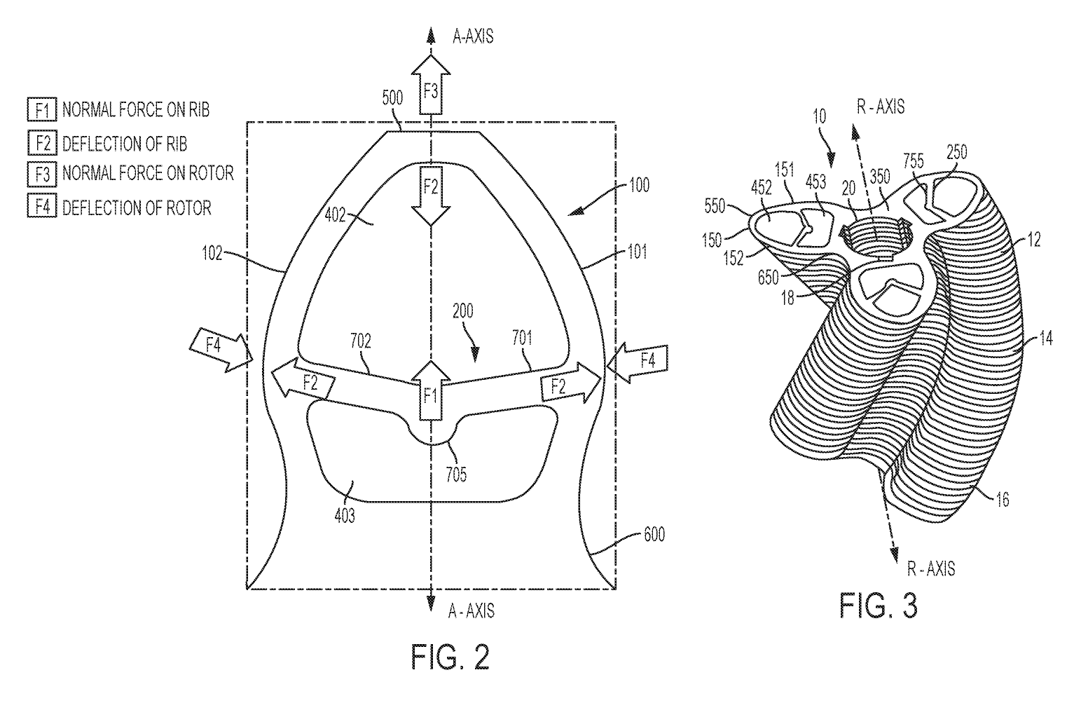

The hollow lobes of FIGS. 1A-1E & 3 are designed with a “V” shaped rib 200, 210, 220, 230, 240, 250 across the interior of the hollow lobe. This shape and orientation reduces deflection. The optimal lobe profile along the peripheries of the lobe can be adjusted according to the speed and shape of the rotor. The rotor profiles can be applied to several manufacturing methods such as stacking stamped sheets of sheet material and lamination of the stacked stamped sheets, as in FIG. 3. Or, the rotor profiles can be applied to investment cast rotors. When using the stacked, stamped sheets, the general shape of the rib 200, 210, 220, 230, 240, 250 can be common to the lobes 100, 110, 120, 130, 140, 150, although the rib can change orientation and location depending on the desired force direction and force magnitude along the length of the rotor axis R-R.

A rotor can comprise a central body 300, 310, 320, 330, 340, 350 configured to rotate. A lobe 100, 110, 120, 130, 140, 150 extends from the central body. The lobe comprises a lobe axis A-A perpendicular to the central body. When the rotor is rotated, it can be in a clockwise or counter-clockwise direction with respect to the rotor axis R-R. The rotor can be used to pump a fluid, and the portion of the lobe that first moves in to the fluid can be considered a leading periphery 101,111, 121, 131, 141, 151. The portion of the lobe that follows can be considered a trailing periphery 102, 112, 122, 132, 142, 152. For purposes of explanation, the rotors of the figures are explained as if they are moving clockwise with respect to the rotor axis R-R, but is it to be understood that the leading periphery and trailing periphery designations are reversible if the rotation direction should be reversed.

The lobes 100, 110, 120, 130, 140, 150 can be used in sets to form a first rotor profile and a second rotor profile so that the lobes of the first rotor mesh between the lobes of the second rotor to pump a fluid. The curvature of the rotor peripheries 101,111, 121, 131, 141, 151, 102, 112, 122, 132, 142, 152, connections 500, 510, 520, 530, 540, 550, and root portions 600, 610, 620, 630, 640, 650 can be selected among many design choices and application-specific shapes depending on such factors as rotational speed, intended fluid for pumping, operating temperature, compression ratio, among others. Thus, the illustrated involute rotor profiles are exemplary and can be adjusted. For example, cycloid or complex cycloid profiles can be selected. The root portion 600, 610, 620, 630, 640, 650 of the rotors, between the lobes and near the central body 300, 310, 320, 330, 340, 350, can have other shapes depending on design choice and factors such as how the tips or connections 500, 510, 520, 530, 540, 550 of a corresponding rotor should move therebetween.

A curved leading periphery 101, 111, 121, 131, 141, 151 is on a first side of the lobe axis A-A and a curved trailing periphery is on a second side of the lobe axis A-A. The lobe axis A-A is perpendicular to the rotor axis R-R. The rotor rotates about the rotor axis R-R. Stamped sheets of a sheet material, such as steel or aluminum, can be stacked along the rotor axis R-R to form a twisted rotor, as shown in FIG. 3. The twisted rotor comprises lobe axis A-A that are offset from one lobe in a stack to the next lobe in the stack along the rotor axis R-R. For example, the lobe axis for the right-most lobe of rotor 12 is perpendicular to the rotor axis R-R, but is not parallel to either the lobe axis for the right-most lobe of rotor 14 nor the lobe axis for the right-most lobe of rotor 16. It is possible in some implementations that the lobe axis for the right-most lobe of rotor 12 to be parallel to the lobe axis of the left-most lobe of rotor 16, among other variations. Additional alternatives comprise parallel lobes, where the lobe axis A-A of one lobe is parallel to that of the lobe stacked next to it along the rotor axis R-R. While rotors comprising 3 or 4 lobes are drawn, more or fewer lobes can be used per rotor, for example 2 or 5 lobes, among others.

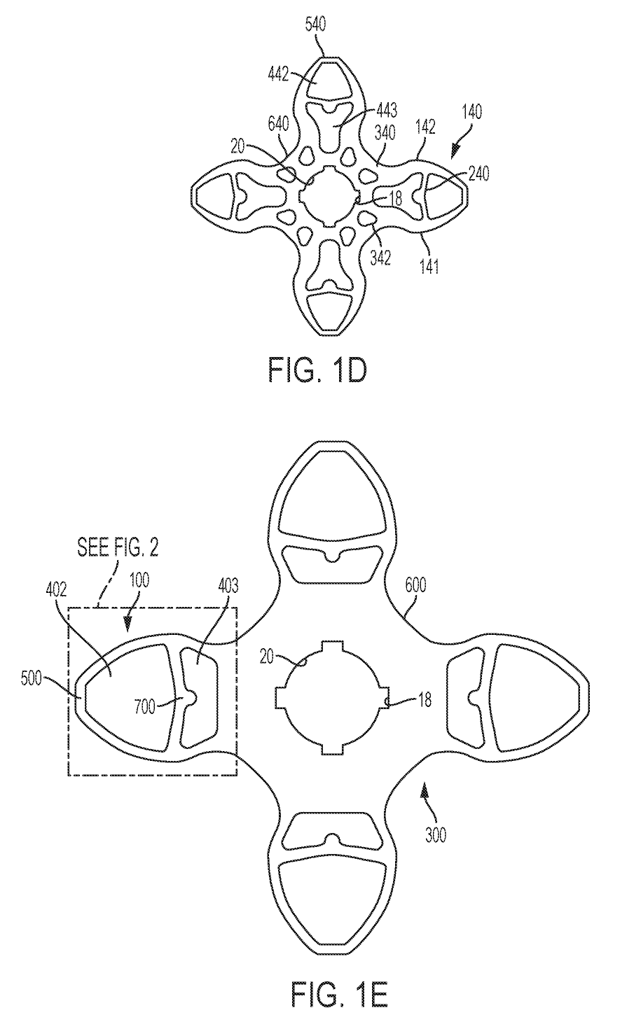

Turning to FIG. 2, when the central body 300 rotates, inward deflection forces F4 act on the lobe 100 such that the curved leading periphery 101 tends to deflect towards the lobe axis A-A. However, outward deflection forces F2 act via the V-shaped rib 200 to counter the inward deflection forces F4. And, when the central body 300 rotates, normal forces F3 act on the connection 500 at the tip of the rotor to extend the connection 500 distally along the lobe axis A-A. However, normal rib forces F1 and outward deflection forces F2 act on the V-shaped rib 200 to counter the normal forces F3. The countering effects inure when the outward deflection forces F2 act on the curved leading periphery 101 and on the curved trailing periphery 102.

So, a V-shaped rib 200 spans between the curved leading periphery 101 and the curved trailing periphery 102. A first hollow space 402 is bounded by the V-shaped rib 200, the curved leading periphery 101, and the curved trailing periphery 102. The first hollow space 402 is distal with respect to the central body 300 along the lobe axis A-A. A second hollow space 403 is bounded by the V-shaped rib 200, the central body 300, the curved leading periphery 101, and the curved trailing periphery 102. The second hollow space 403 is proximal with respect to the central body 300 along the lobe axis A-A. The rotor can comprise a single piece of material, or can comprise a plurality of stacked, stamped sheets of sheet material arranged to form a helically twisted supercharger rotor.

The V-shaped rib 200 can comprise a vertex 700 proximal with respect to the central body 300 along the lobe axis A-A. The vertex 700 can point in the direction of the central body 300 while the arms of the V-shaped rib reach away from the central body. So, a first arm 701 can extend from the vertex 700 to connect to the curved leading periphery 101 distal with respect to the central body 300 along the lobe axis A-A. A second arm 702 can extend from the vertex 700 to connect to the curved trailing periphery 102 distal with respect to the central body 300 along the lobe axis A-A.

The normal force F3 increases with increasing distance of the connection 500 from the rotor axis R-R and also due to mass and angular velocity factors. So, it is beneficial to have a way of adjusting the rib normal force F1 for the rotor application. So, a weighting body 705 is formed at the vertex 700. A disc or knurl shape can be formed proximal with respect to the central body 300 along the lobe axis A-A. However, other shapes can be used. For example, a circle shape is applied to the weighting body 735 of FIG. 1C.

FIG. 2 describes how the inertia forces act to oppose the outer profile reduction and tip growth. The main force acting on the spinning lobe is normal force F3, where the normal forces F3 are represented by:

F3=M*R*wω\hat{ }2 (eq. 1)

where M is mass, R is the radial distance from the rotational rotor axis R-R, and w is the angular velocity of the rotor.

The normal force F3 is illustrated as a thick arrow, and the normal force F3 acts in a direction normal to the axis of rotation (rotor axis R-R), and tends to displace the rotor tip (connection 500) outward and to pull the peripheries of the rotor lobe inward, as illustrated by inward deflection forces F4. This is because the normal force F3 is typically higher at the tip since the radial distance R from the rotational rotor axis R-R is larger.

The “V’ shaped rib is designed such that the inertial loading on the rib forces the rib supports out against the lobe walls, which counteracts the force trying to pull the lobes inward. These rib forces are illustrated as thick arrows F1 and F2. This also acts to constrain the rotor tip deflection.

In a rotor 10, such as shown in FIG. 3, the location of the weighting body 755 can change from lobe to lobe along the rotor axis R-R due to the aggregation of forces. This permits additional anti-deflection tailoring. For example, rotor 10 can be used in an axial inlet, radial outlet supercharger application. This causes rotor 10 to experience a heat gradient along the length of the rotor during certain operating conditions. By adjusting the location of the rib 250, and additionally or alternatively adjusting the attributes of the weighting body 755, additional factors can be addressed. For example, thermal growth can be accounted for along with the deflection forces. So, it is possible that at rotor 12 of FIG. 3, the rib 250 is positioned differently than the ribs for rotors 14 and 16. Likewise, the weighting body 755 can differ in size among the ribs for rotors 12, 14, 16 etc. For example, when applied to a radial inlet, radial outlet pump, the ribs and weighting bodies of rotors 12 and 16 can be the same, while the rib and weighting body for the rotor 14 differs from rotors 12 & 16.

The tips of the lobes can be pointed, or, as drawn in FIGS. 1A-1E can be flattened to provide a flattened periphery at the most distal portion of the lobe. Or, as shown in FIG. 3, the tips of the lobes can be slightly curved. The shape of the tips and area of material forming the connections can depend upon such factors as sealing and thermal growth with respect to a rotor enclosure. Connection 500, 510, 520, 530, 540, 550 can comprise an area of material that is distal with respect to the central body along the lobe axis A-A. As drawn, the connection 500 spans between the curved leading periphery 101 and the curved trailing periphery 102.

In addition to the variants discussed above, other aspects of the rotors can be varied. For example, it is possible to design the lobes so that the curved leading periphery 101 comprises a uniform thickness along the lobe axis A-A, as drawn in FIG. 2. Or, the curved leading periphery 121 can comprise a non-uniform thickness along the lobe axis A-A such that the curved leading periphery is thicker proximal to the central body 320 and is thinner distal to the central body 320, as drawn in FIG. 1B. The central body 340 can comprises hollow pockets 342, as shown in FIG. 1D. The first and second hollow spaces 402, 403, 412, 413, 422, 423, 432, 433, 442, 443, 452, 453 can be made larger or smaller, can be made alternative shapes, or can extend in to a portion of the central body as shown in the central bodies 310, 320, 340 of FIGS. 1A, 1B & 1D.

The central body can comprises a shaft opening 20 for receiving a rotatable shaft. When forming a rotor 10 comprised of stamped stacked sheets of sheet material, the shaft opening 20 can comprise alignment slots 18 for aligning the rotors with respect to the rotatable shaft. The rotatable shaft can be a mandrel with alignment features configured to align with the alignment slots 18.

Other implementations will be apparent to those skilled in the art from consideration of the specification and practice of the examples disclosed herein.

1. A rotor comprising:
a central body configured to rotate;
a lobe extending from the central body, the lobe comprising: an lobe axis perpendicular to the central body;
a curved leading periphery on a first side of the lobe axis;
a curved trailing periphery on a second side of the lobe axis;
a V-shaped rib spanning between the curved leading periphery and the curved trailing periphery;
a first hollow space bounded by the V-shaped rib, the curved leading periphery, and the curved trailing periphery, the first hollow space distal with respect to the central body along the lobe axis; and
a second hollow space bounded by the V-shaped rib, the central body, the curved leading periphery, and the curved trailing periphery, the second hollow space proximal with respect to the central body along the lobe axis.

2. The rotor of claim 1, wherein the V-shaped rib comprises:
a vertex proximal with respect to the central body along the lobe axis; a first arm extending from the vertex to connect to the curved leading
periphery distal with respect to the central body along the lobe axis; and a second arm extending from the vertex to connect to the curved trailing
periphery distal with respect to the central body along the lobe axis.

3. The rotor of claim 2 further comprising a weighting body formed at the vertex proximal with respect to the central body along the lobe axis.

4. The rotor of claim 1, further comprising a connection distal with respect to the central body along the lobe axis, the connection spanning between the curved leading periphery and the curved trailing periphery.

5. The rotor of claim 4, wherein the connection provides a flat periphery at the most distal portion of the lobe.

6. The rotor of claim 5, wherein, when the central body rotates, inward deflection forces act on the lobe such that the curved leading periphery tends to deflect towards the lobe axis, and outward deflection forces act via the V-shaped rib to counter the inward deflection forces.

7. The rotor of claim 5, wherein, when the central body rotates about a rotor axis, normal forces act on the connection to extend the connection distally along the lobe axis, and outward deflection forces act on the V-shaped rib to counter the normal forces when the outward deflection forces act on the curved leading periphery and on the curved trailing periphery.

8. The rotor of claim 7, wherein the normal forces (F3) are represented by
F3=M*R*wA2
where M is mass, R is the radial distance from the rotational rotor axis, and w is the angular velocity of the rotor.

9. The rotor of claim 1, wherein the curved leading periphery comprises a uniform thickness along the lobe axis.

10. The rotor of claim 1, wherein the curved leading periphery comprises a non-uniform thickness along the lobe axis such that the curved leading periphery is thicker proximal to the central body and is thinner distal to the central body.

11. The rotor of claim 1, wherein the central body comprises hollow pockets.

12. The rotor of claim 1, wherein the central body comprises a shaft opening for receiving a rotatable shaft.

13. The rotor of claim 12, wherein the shaft opening comprises alignment slots.

14. The rotor of claim 1, wherein the rotor comprises a stamped sheet material.

15. The rotor of claim 1, wherein the rotor comprises a plurality of stacked, stamped sheets of sheet material.

16. The rotor of claim 2, further comprising a connection distal with respect to the central body along the lobe axis, the connection spanning between the curved leading periphery and the curved trailing periphery.

17. The rotor of claim 3, further comprising a connection distal with respect to the central body along the lobe axis, the connection spanning between the curved leading periphery and the curved trailing periphery.
